(19) United States
(12) Patent Application Publication
(10) Pub. No.: US 2015/0270567 A1
(43) Pub. Date: Sep. 24, 2015

(54) PROCESS FOR PRODUCING MEMBRANE/ELECTRODE ASSEMBLY FOR POLYMER ELECTROLYTE FUEL CELL AND PASTE FOR FORMING INTERLAYER

(71) Applicant: Asahi Glass Company, Limited, Chiyoda-ku (JP)

(72) Inventors: Toshihiro TANUMA, Chiyoda-ku (JP); Hiroshi SHIMODA, Chiyoda-ku (JP)

(73) Assignee: Asahi Glass Company, Limited, Chiyoda-ku (JP)

(21) Appl. No.: 14/637,994

(22) Filed: Mar. 4, 2015

(30) Foreign Application Priority Data
Mar. 24, 2014 (JP) 2014-059973

(51) Int. Cl. H01M 8/10; C09J 9/02; H01M 8/02

(52) U.S. Cl. CPC H01M 8/1002; H01M 8/0243; H01M 8/0226; H01M 8/1069; H01M 8/1081; C09J 9/02; H01M 2008/1095

(57) ABSTRACT

To provide a process for producing a membrane/electrode assembly for a polymer electrolyte fuel cell, by which the effect of improving power generation performance by providing an interlayer between a catalyst layer and a gas diffusion layer is sufficiently exhibited, and a paste for forming an interlayer suitable for the production process.

A process for producing a membrane/electrode assembly for a polymer electrolyte fuel cell, comprising (a) a step of forming a first wet film 134 by coating the surface of a first carrier film 50 with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis, (b) a step of forming a second wet film 132 by coating the surface of the first wet film 134 with a paste for forming a catalyst layer, said paste comprising a catalyst, an ion exchange resin and a liquid medium, and (c) a step of forming an interlayer 34 and a catalyst layer 32, by drying the first wet film 134 and the second wet film 132.

### FIELD OF INVENTION

The present invention relates to a process for producing a membrane/electrode assembly for a polymer electrolyte fuel cell, and a paste to be used for forming an interlayer constituting electrodes for a membrane/electrode assembly for a polymer electrolyte fuel cell.

### BACKGROUND OF INVENTION

A polymer electrolyte fuel cell is, for example, a stack of a plurality of cells each comprising a membrane/electrode assembly sandwiched between two separators. The membrane/electrode assembly is one comprising an anode and a cathode each having a catalyst layer and a gas diffusion layer, and a polymer electrolyte membrane disposed between the anode and the cathode.

It is likely that an interlayer containing a carbon material and a polymer is disposed between a catalyst layer and a gas diffusion layer, in order to improve electrical conductivity, gas diffusing property and water drainage property in electrodes, especially in a cathode, and thereby to enhance power generation performance of a membrane/electrode assembly, (e.g. Patent Document 1).

### PRIOR ART DOCUMENTS

### Patent Document

Patent Document 1: WO2011/114949

### Technical Problem

An electrode having an interlayer is produced by the following process:

A process comprising coating the surface of a gas diffusing base material constituting a gas diffusion layer, with a paste for forming an interlayer containing a carbon material, a polymer and a liquid medium, followed by drying to form an interlayer, and then coating the surface of the interlayer with a paste for forming a catalyst layer containing a catalyst, an ion exchange resin and a liquid medium, followed by drying to form a catalyst layer (paragraph [0078] in Patent Document 1).

However, in an electrode produced by the above process, the adhesion at the interface between the interlayer and the catalyst layer is low. Further, the paste for forming an interlayer penetrates through the gas diffusing base material, whereby spot-like unevenness occurs to the interlayer, and as a result, spot-like unevenness also occurs to the catalyst layer. Accordingly, there is a problem such that the effect of improving power generation performance of a membrane/electrode assembly by providing the interlayer is not sufficiently exhibited.

The present invention provides a process for producing a membrane/electrode assembly for a polymer electrolyte fuel cell, by which the effect to improve power generation performance by providing an interlayer between a catalyst layer and a gas diffusion layer is sufficiently exhibited, and a paste for forming an interlayer suitable for the production process.

### Solution to Problem

The process for producing a membrane/electrode assembly for a polymer electrolyte fuel cell is a process for producing a membrane/electrode assembly for a polymer electrolyte fuel cell, said membrane/electrode assembly comprising an anode having a catalyst layer and a gas diffusion layer, a cathode having a catalyst layer and a gas diffusion layer, and a polymer electrolyte membrane disposed between the catalyst layer of the anode and the catalyst layer of the cathode, wherein either or both of the anode and the cathode have an interlayer between the catalyst layer and the gas diffusion layer,

which process comprises the following steps (a), (b) and (c):

(a) a step of forming a first wet film by coating the surface of a base material with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,

(b) a step of forming a second wet film by coating the surface of the first wet film with a paste for forming a catalyst layer, subsequent to the step (a), said paste comprising a catalyst, an ion exchange resin and a liquid medium, and

(c) a step of forming an interlayer and a catalyst layer, by drying the first wet film and the second wet film, subsequent to the step (b).

In the membrane/electrode assembly for a polymer electrolyte fuel cell, it is preferred that at least the cathode has the interlayer.

It is preferred that the step (b) is carried out while the remaining ratio of the liquid medium in the first wet film is at least 40%.

The process for producing a membrane/electrode assembly for a polymer electrolyte fuel cell of the present invention may be a process, wherein the step (a) is the following step (a′):

(a′) a step of forming a first wet film by coating the surface of a carrier film with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,

which process further comprises the following steps (f′) and (g′):

(f′) a step of obtaining an interlayer-provided membrane/catalyst layer assembly by assembling the polymer electrolyte membrane and the carrier film the surface of which is formed with the interlayer and the catalyst layer so that the catalyst layer is in contact with the polymer electrolyte membrane, subsequent to the step (c), and

(g′) a step of removing the carrier film, and assembling the interlayer-provided membrane/catalyst layer assembly and a gas diffusing base material to constitute the gas diffusion layer so that the interlayer is in contact with the gas diffusing base material, subsequent to the step (f′).

The process for producing a membrane/electrode assembly for a polymer electrolyte fuel cell of the present invention may be a process, wherein the step (a) is the following step (a″):

(a″) a step of forming a first wet film by coating the surface of a gas diffusing base material to constitute the gas diffusion layer, with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,

which process further comprises the following step (f″):

(f″) a step of assembling the polymer electrolyte membrane and the gas diffusing base material the surface of which is formed with the interlayer and the catalyst layer so that the catalyst layer is in contact with the polymer electrolyte membrane, subsequent to the step (c).

It is preferred that the paste for forming an interlayer contains an organic solvent and water as the liquid medium, and the ratio of the organic solvent to the water (organic solvent:water) is from 55:45 to 30:70 (mass ratio).

It is preferred that the paste for forming a catalyst layer contains an organic solvent and water as the liquid medium, and the ratio of the organic solvent to the water (organic solvent:water) is from 70:30 to 45:55 (mass ratio).

The paste for forming an interlayer of the present invention is a paste for forming an interlayer, which is used for producing a membrane/electrode assembly for a polymer electrolyte fuel cell, said membrane/electrode assembly comprising an anode having a catalyst layer and a gas diffusion layer, a cathode having a catalyst layer and a gas diffusion layer, and a polymer electrolyte membrane disposed between the catalyst layer of the anode and the catalyst layer of the cathode, wherein either or both of the anode and the cathode have an interlayer between the catalyst layer and the gas diffusion layer,

which paste comprises a carbon material, a polymer and a liquid medium, and has a viscosity of from 250 to 450 mPa·s at a shear rate of 200 (1/s) as measured at 25° C. by using an RE550 viscometer (manufactured by TOKI SANGYO CO., LTD.) for flow analysis.

### Advantageous Effects of Invention

According to the process for producing a membrane/electrode assembly for a polymer electrolyte fuel cell of the present invention, it is possible to produce a membrane/electrode assembly for a polymer electrolyte fuel cell, by which the effect of improving power generation performance by providing an interlayer between a catalyst layer and a gas diffusion layer is sufficiently exhibited.

The paste for forming an interlayer of the present invention is a paste for forming an interlayer suitable for the process for producing a membrane/electrode assembly for a polymer electrolyte fuel cell of the present invention.

### BRIEF DESCRIPTION OF DRAWINGS

FIG. 1 is a cross-sectional view illustrating one embodiment of the membrane/electrode assembly for a polymer electrolyte fuel cell.

FIG. 2 is a cross-sectional view illustrating another embodiment of the membrane/electrode assembly for a polymer electrolyte fuel cell.

FIG. 3 is a cross-sectional view illustrating a part of steps in the process for producing a membrane/electrode assembly for a polymer electrolyte fuel cell of the present invention.

FIG. 4 is a cross-sectional view illustrating a part of steps in the process for producing a membrane/electrode assembly for a polymer electrolyte fuel cell of the present invention.

FIG. 5 is a cross-sectional view illustrating a part of steps in the process for producing a membrane/electrode assembly for a polymer electrolyte fuel cell of the present invention.

FIG. 6 is a cross-sectional view illustrating a part of steps in the process for producing a membrane/electrode assembly for a polymer electrolyte fuel cell of the present invention.

FIG. 7 is a cross-sectional view illustrating a part of steps in the process for producing a membrane/electrode assembly for a polymer electrolyte fuel cell of the present invention.

### DETAILED DESCRIPTION OF INVENTION

In this specification, structural units represented by the formula (U1) will be referred to as units (U1). Structural units represented by other formulae will be referred to in the same manner.

Further, a monomer represented by the formula (M1) will be referred to as a compound (M1). Monomers represented by other formulae will be referred to in the same manner.

The following definitions of terms will be applied throughout this specification and scope of claims.

“Polymer” means a compound having a structure constituted by a plurality of structural units.

“Structural unit” means a unit derived from a monomer, which is formed by polymerizing the monomer. The structural unit may be a unit formed directly by the polymerization reaction of the monomer, or may be a unit in which a part of the unit is converted to another structure by treating the polymer.

“Monomer” means a compound having a carbon-carbon double bond with polymerizability.

“Ion exchange group” means a group having H⁺, a monovalent metal cation, an ammonium ion or the like. The ion exchange group may, for example, be a sulfonic acid group, a sulfonimide group or a sulfonmethide group.

“Wet film” means a film in which the remaining ratio of the liquid medium is at least 40 mass %.

“Remaining ratio of liquid medium” is determined from the following formula where X1 represents a mass of a liquid medium contained in a wet film immediately after a paste is applied, and X2 represents a mass of the liquid medium contained in the wet film after the liquid medium is somewhat volatilized.

Remaining ratio of liquid medium=(X2/X1)×100

X1 may be calculated from the apply amount of the paste and the solid content concentration of the paste. X2 may be calculated from the difference (that is, a volatilization of liquid medium (X1−X2)) between the mass of the entire article having the wet film immediately after application of the paste and the mass of the entire article having the wet film after the liquid medium is somewhat volatilized.

### <Membrane/Electrode Assembly>

The membrane/electrode assembly for a polymer electrolyte fuel cell (which may be hereinafter referred to simply as a membrane/electrode assembly) obtainable by the production process of the present invention is one comprising an anode having a catalyst layer and a gas diffusion layer, a cathode having a catalyst layer and a gas diffusion layer, and a polymer electrolyte membrane disposed between the catalyst layer of the anode and the catalyst layer of the cathode, wherein either or both of the anode and the cathode have an interlayer between the catalyst layer and the gas diffusion layer.

In the membrane/electrode assembly, at least the cathode preferably has the interlayer.

Reactions in the polymer electrolyte fuel cell are represented by the following formulae (R1) and (R2):

Anode: H₂→2H⁺+2e⁻ (R1)

Cathode: 2H⁺+½O₂+2e⁻→H₂O (R2)

In the polymer electrolyte fuel cell, the reaction represented by (R2) in the cathode has been known to be a rate-determining step, and in order to accelerate the reaction, it is necessary to increase a proton concentration and an oxygen concentration in the reaction site. Accordingly, the cathode is required to have sufficient electrical conductivity and gas diffusing property. Further, in order to maintain the electrical conductivity of the cathode, highly humidified oxidant gas (air) humidified by e.g. a humidifying device is supplied to the cathode. Further, in the cathode, water vapor is generated by the reaction, and therefore clogging of pores (flooding) by condensation of water vapor is likely to occur. Accordingly, the cathode is also required to have sufficient water drainage property.

Therefore, it is preferred that at least the cathode has an interlayer for improving electrical conductivity, gas diffusing property and water drainage property, between the catalyst layer and the gas diffusion layer.

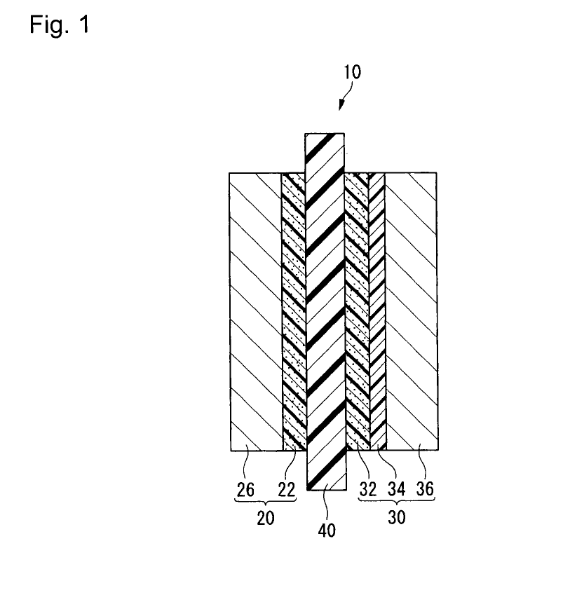

FIG. 1 is a cross-sectional view illustrating one embodiment of the membrane/electrode assembly.

The membrane/electrode assembly 10 is one comprising an anode 20 having a catalyst layer 22 and a gas diffusion layer 26; a cathode 30 having a catalyst layer 32, an interlayer 34 and a gas diffusion layer 36 in this order; and a polymer electrolyte membrane 40 disposed between the catalyst layer 22 of the anode 20 and the catalyst layer 32 of the cathode 30.

### (Catalyst Layer)

The catalyst layer 22 and the catalyst layer 32 (which may be hereinafter generally referred to as a catalyst layer) are a layer comprising a catalyst and an ion exchange resin. The catalyst layer 22 and the catalyst layer 32 may be the same layers or different layers with respect to e.g. the components, composition and thickness.

The catalyst may be any catalyst so long as it accelerates an oxidation/reduction reaction in a polymer electrolyte fuel cell, and it is preferably a catalyst containing platinum, particularly preferably a supported catalyst having platinum or a platinum alloy supported on a carbon carrier.

The carbon carrier may, for example, be activated carbon or carbon black, and it is preferably one graphitized by e.g. heat treatment, since its chemical durability is high.

The specific surface area of the carbon carrier is preferably at least 200 m²/g. The specific surface area of the carbon carrier is measured by a BET specific surface area measuring device by adsorption of nitrogen on a carbon surface.

The platinum alloy is preferably an alloy of platinum with at least one metal selected from the group consisting of platinum group metals excluding platinum (such as ruthenium, rhodium, palladium, osmium and iridium), gold, silver, chromium, iron, titanium, manganese, cobalt, nickel, molybdenum, tungsten, aluminum, silicon, zinc and tin. Such a platinum alloy may contain an intermetallic compound of platinum and a metal to be alloyed with platinum.

The amount of platinum or a platinum alloy supported is preferably from 10 to 70 mass %, based on the supported catalyst (100 mass %).

The ion exchange resin is preferably a fluorinated ion exchange resin, more preferably a perfluorocarbon polymer having ion exchange groups (which may contain an etheric oxygen atom), from the viewpoint of the durability. As such a perfluorocarbon polymer, a known polymer such as the following polymer (H) or polymer (Q), or a polymer having units derived from a perfluoromonomer having an ion exchange group and a 5-membered ring, as described in WO2011/013577, may be mentioned, and the polymer (H) or polymer (Q) is preferred from the viewpoint of availability and productivity.

### Polymer (H):

The polymer (H) is a polymer having units (U1) (provided that polymer (Q) is excluded).

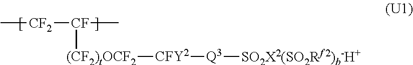

wherein Q³ is a single bond or a perfluoroalkylene group which may have an etheric oxygen atom, R^{f2} is a perfluoroalkyl group which may have an etheric oxygen atom, X² is an oxygen atom, a nitrogen atom or a carbon atom, b is 0 when X² is an oxygen atom, 1 when X² is a nitrogen, and 2 when X² is a carbon atom, Y² is a fluorine atom or a monovalent perfluoroorganic group, and t is 0 or 1. The single bond means that the carbon atom of CFY² is directly bonded to the sulfur atom of SO₂. The organic group means a group containing at least one carbon atom.

In a case where the perfluoroalkylene group for Q³ has an etheric oxygen atom, the number of such oxygen atoms may be one or more. Further, such an oxygen atom may be inserted in a carbon atom-carbon atom bond of the perfluoroalkylene group, or may be inserted at the terminal of a carbon atom bond.

The perfluoroalkylene group may be linear or branched.

The number of carbon atoms in the perfluoroalkylene group is preferably from 1 to 6, more preferably from 1 to 4.

The perfluoroalkyl group for R^{f2} may be linear or branched, preferably linear.

The number of carbon atoms in the perfluoroalkyl group is preferably from 1 to 6, more preferably from 1 to 4. The perfluoroalkyl group is preferably a perfluoromethyl group, a perfluoroethyl group or the like.

The —(SO₂X²(SO₂R^{f2})_{b})⁻H⁺ group is an ion exchange group. The —(SO₂X²(SO₂R^{f2})_{b})⁻H⁺ group may, for example, be a sulfonic acid group (—SO³⁻H⁺ group), a sulfonimide group (—SO₂N(SO₂R^{f2})⁻H⁺ group), or a sulfonmethide group (—SO₂C(SO₂R^{f2})₂)⁻H⁺ group).

Y² is preferably a fluorine atom or a trifluoromethyl group.

Unit (U1) is preferably unit (U1-1), more preferably unit (U1-11), unit (U1-12), unit (U1-13) or unit (U1-14), since production of the polymer (H) is thereby easy, and industrial application is easy.

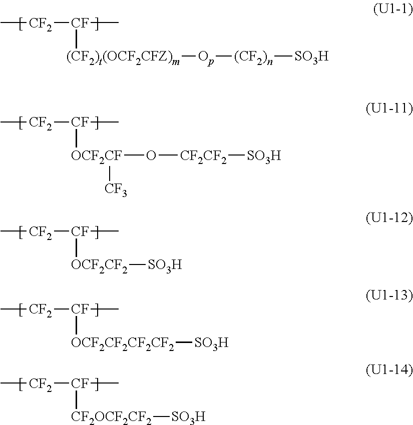

wherein Z is a fluorine atom or a trifluoromethyl group, m is an integer of from 0 to 3, n is an integer of from 1 to 12, and p is 0 or 1, provided that m+p>0.

The polymer (H) may further have repeating units based on another monomer (hereinafter referred to as other units). The proportion of such other units may suitably be adjusted so that the ion exchange capacity of the polymer (H) will be within the after-mentioned preferred range.

Such other units are preferably repeating units based on a perfluoromonomer, more preferably repeating units based on tetrafluoroethylene (hereinafter referred to as TFE) from the viewpoint of mechanical strength and chemical durability.

The polymer (H) may be produced by polymerizing the compound (M1) and other monomers as the case requires to obtain a precursor polymer, and then converting the —SO₂F group in the precursor polymer to a sulfonic acid group. The conversion of the —SO₂F group to the sulfonic acid group is carried out by hydrolysis and conversion to an acid-form.

CF₂═CF—(CF₂)ₜOCF₂—CFY²-Q³-SO₂F (M1)

### Polymer (Q):

The polymer (Q) is a polymer having units (U2).

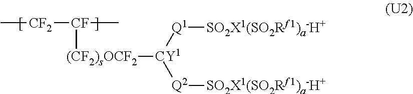

wherein Q¹ is a perfluoroalkylene group which may have an etheric oxygen atom, Q² is a single bond or a perfluoroalkylene group which may have an etheric oxygen atom, R^{f1} is a perfluoroalkyl group which may have an etheric oxygen atom, X¹ is an oxygen atom, a nitrogen atom or a carbon atom, a is 0 when X¹ is an oxygen atom, 1 when X¹ is a nitrogen atom, and 2 when X¹ is a carbon atom, Y¹ is a fluorine atom or a monovalent perfluoro organic group, and s is 0 or 1. The single bond means that the carbon atom of CY¹ is directly bonded to the sulfur atom of SO₂. The organic group means a group containing at least one carbon atom.

In a case where the perfluoroalkylene group for Q¹ or Q² has an etheric oxygen atom, the number of such oxygen atoms may be one or more. Further, such an oxygen atom may be inserted in a carbon atom-carbon atom bond of the perfluoroalkylene group, or may be inserted at the terminal of a carbon atom bond.

The perfluoroalkylene group may be linear or branched, preferably linear.

The number of carbon atoms in the perfluoroalkylene group is preferably from 1 to 6, more preferably from 1 to 4. When the number of carbon atoms is at most 6, the boiling point of the fluoromonomer as the starting material tends to be low, whereby purification by distillation will be easy.

Q² is preferably a C₁₋₆ perfluoroalkylene group which may have an etheric oxygen atom. When Q² is a C₁₋₆ perfluoroalkylene group which may have an etheric oxygen atom, the polymer electrolyte fuel cell will be excellent in the stability of the power generation performance when it is operated over a long period, as compared with a case where Q² is a single bond.

It is preferred that at least one of Q¹ and Q² is a C₁₋₆ perfluoroalkylene group having an etheric oxygen atom. The fluorinated monomer having a C₁₋₆ perfluoroalkylene group having an etheric oxygen atom can be synthesized without a fluorination reaction by fluorine gas, whereby the yield is good, and the production is easy.

The perfluoroalkyl group for R^{f1} may be linear or branched, preferably linear.

The number of carbon atoms in the perfluoroalkyl group is preferably from 1 to 6, more preferably from 1 to 4. The perfluoroalkyl group is preferably a perfluoromethyl group, a perfluoroethyl group or the like.

In a case where unit (U2) has at least two R^{f1}, the plurality of R^{f1} may be the same or different from one another.

The —(SO₂X¹(SO₂R^{f1})ₐ)⁻H⁺ group is an ion exchange group.

The —(SO₂X¹(SO₂R^{f1})ₐ)⁻H⁺ group may, for example, be a sulfonic acid group (—SO₂H⁺ group), a sulfonimide group (—SO₂N(SO₂R^{f1})⁻H⁺ group), or a sulfonmethide group (—SO₂C(SO₂R^{f1})₂)⁻H⁺ group).

Y¹ is preferably a fluorine atom or a C₁₋₆ linear perfluoroalkyl group which may have an etheric oxygen atom.

Unit (U2) is preferably unit (U2-1), more preferably unit (U2-11), unit (U2-12) or unit (U2-13), since production of the polymer (Q) is thereby easy, and industrial application is easy.

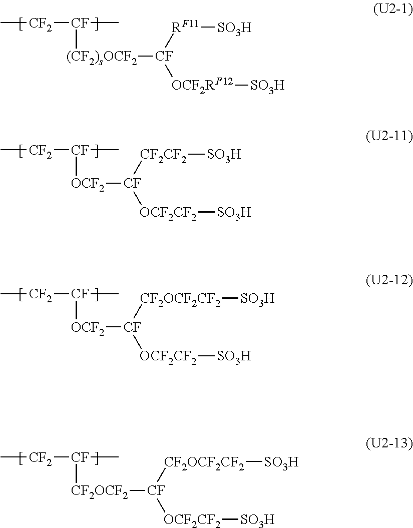

wherein R^{F11} is a single bond or a C₁₋₆ linear perfluoroalkylene group which may have an etheric oxygen atom, and R^{F12} is a C₁₋₆ linear perfluoroalkylene group.

The polymer (Q) may further have other units. The proportion of such other units may suitably be adjusted so that the ion exchange capacity of the polymer (Q) will be within the after-mentioned preferred range.

Such other units are preferably repeating units based on a perfluoromonomer, more preferably repeating units based on TFE, from the viewpoint of mechanical strength and chemical durability.

The polymer (Q) may be produced in accordance with the process as described in e.g. WO2007/013533.

The ion exchange capacity of the fluorinated ion exchange resin is preferably from 0.5 to 2.0 meq/g dry resin, particularly preferably from 0.8 to 1.5 meq/g dry resin, from the viewpoint of the electrical conductivity and gas permeability.

The amount of platinum contained in the catalyst layer is preferably from 0.01 to 0.5 mg/cm² from the viewpoint of the optimum thickness to carry out the electrode reaction efficiently, more preferably from 0.05 to 0.35 mg/cm² from the viewpoint of the balance of the cost of materials and the performance.

### (Interlayer)

The interlayer 34 is a layer containing a carbon material and a polymer.

The carbon material may, for example, be carbon particles or carbon fibers, and carbon fibers are preferred from the viewpoint that the effect of improving power generation performance is sufficiently exhibited.

The carbon particles may, for example, be carbon black.

The carbon fibers may, for example, be vapor phase-grown carbon fibers, carbon nanotubes (single-wall, double-wall, multiwall or cup-stacked-type, etc.), PAN-type carbon fibers or pitch-type carbon fibers.

The carbon fibers may be in the form of chopped fibers or milled fibers.

The average fiber diameter of the carbon fibers is preferably from 30 to 200 nm, more preferably from 50 to 150 nm. When the average fiber diameter of the carbon fibers is at least the lower limit value, the interlayer 34 has good gas diffusion property and water drainage property. When the average fiber diameter of the carbon fibers is at most the upper limit value, the carbon fibers can be dispersed well in a dispersing medium.

The polymer may, for example, be a fluorinated polymer (provided that a fluorinated ion exchange resin is extruded) or a fluorinated ion exchange resin, and a fluorinated ion exchange resin is preferred from the viewpoint of durability of the interlayer and the dispersion stability of the carbon fibers.

The fluorinated polymer may, for example, be polytetrafluoroethylene (PTFE).

The fluorinated ion exchange resin is preferably a perfluorocarbon polymer having ion exchange groups, particularly preferably the above-mentioned polymer (H) or polymer (Q).

The ion exchange capacity of the fluorinated ion exchange resin is preferably from 0.5 to 2.0 meq/g dry resin, particularly preferably from 0.8 to 1.5 meq/g dry resin from the viewpoint of the electrical conductivity and gas permeability.

### (Gas Diffusion Layer)

The gas diffusion layer 26 and the gas diffusion layer 36 (which may be hereinafter generally referred to as a gas diffusion layer) are a layer made of a gas diffusing base material. The gas diffusion layer 26 and the gas diffusion layer 36 may be the same layers or different layers with respect to the components, composition, thickness, etc.

The gas diffusing base material may, for example, be carbon paper, carbon cloth or carbon felt.

### (Polymer Electrolyte Membrane)

The polymer electrolyte membrane 40 is a membrane made of an ion exchange resin.

From the viewpoint of the durability, the ion exchange resin is preferably a fluorinated ion exchange resin, more preferably a perfluorocarbon polymer having ion exchange groups (which may have etheric oxygen atoms), particularly preferably the above-mentioned polymer (H) or polymer (Q).

The ion exchange capacity of the fluorinated ion exchange resin is preferably from 0.5 to 2.0 meq/g dry resin, particularly preferably from 0.8 to 1.5 meq/g dry resin.

The thickness of the polymer electrolyte membrane 40 is preferably from 10 to 30 μm, more preferably from 15 to 25 μm. When the thickness of the polymer electrolyte membrane 40 is at most 30 μm, it is possible to prevent deterioration of the power generation performance of the polymer electrolyte fuel cell under low humidity conditions. Further, by adjusting the thickness of the polymer electrolyte membrane 40 to be at least 10 μm, it is possible to prevent gas leakage or electrical short-circuiting.

The thickness of the polymer electrolyte membrane 40 is measured by observing the cross-section of the polymer electrolyte membrane 40 by means of e.g. a scanning electron microscope.

### Another Embodiment

The membrane electrode assembly is not limited to one shown in FIG. 1.

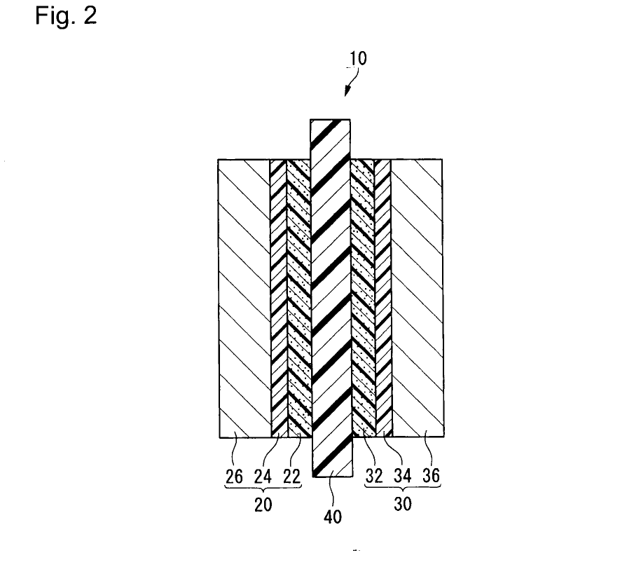

For example, as shown in FIG. 2, the anode 20 may have an interlayer 24 between the catalyst layer 22 and the gas diffusion layer 26.

Further, the cathode 30 may have at least two interlayers, and the anode 20 may have at least two interlayers.

Further, the polymer electrolyte membrane 40 may be reinforced with a reinforcing material, and the catalyst layer may be reinforced with a reinforcing material.

The reinforcing material may, for example, be porous body, fibers, woven fabric or nonwoven fabric.

The polymer electrolyte membrane 40 may contain cerium ions or manganese ions, and the catalyst layer may contain cerium ions.

### <Process for Producing Membrane/Electrode Assembly>

The process for producing a membrane/electrode assembly of the present invention is a process comprising at least the following steps (a), (b) and (c):

(a) a step of forming a first wet film by coating the surface of a base material with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,

(b) a step of forming a second wet film by coating the surface of the first wet film with a paste for forming a catalyst layer, subsequent to the step (a), said paste comprising a catalyst, an ion exchange resin and a liquid medium, and

(c) a step of forming an interlayer and a catalyst layer, by drying the first wet film and the second wet film, subsequent to the step (b).

As the base material, a carrier film or a gas diffusing base material may be mentioned. Specific examples of the process for producing a membrane/electrode assembly of the present invention are roughly classified into the following process (α) (a case where the base material is a carrier film) and the following process (β) (a case where the base material is a gas diffusing base material).

### Process (α):

The process (α) is a process, wherein the step (a) is the following step (a′):

(a′) a step of forming a first wet film by coating the surface of a carrier film with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,

which process further comprises the following steps (f′) and (g′):

(f′) a step of obtaining an interlayer-provided membrane/catalyst layer assembly by assembling the polymer electrolyte membrane and the carrier film the surface of which is formed with the interlayer and the catalyst layer so that the catalyst layer is in contact with the polymer electrolyte membrane, subsequent to the step (c), and

(g′) a step of removing the carrier film, and assembling the interlayer-provided membrane/catalyst layer assembly and a gas diffusing base material to constitute the gas diffusion layer so that the interlayer is in contact with the gas diffusing base material, subsequent to the step (f′).

### Process (β):

The process (β) is a process, wherein the step (a) is the following step (a″):

(a″) a step of forming a first wet film by coating the surface of a gas diffusing base material to constitute the gas diffusion layer, with a paste for forming an interlayer, said paste containing a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,

which process further comprises the following step (f″):

(f″) a step of assembling the polymer electrolyte membrane and the gas diffusing base material the surface of which is formed with the interlayer and the catalyst layer so that the catalyst layer is in contact with the polymer electrolyte membrane, subsequent to the step (c).

Now, the process (α) and the process (β) will be described in detail with reference to the case of producing a membrane/electrode assembly 10 shown in FIG. 1.

### (Process (α))

In the case of producing the membrane/electrode assembly 10 shown in FIG. 1, the process (α) has e.g. the following steps (a′), (b), (c), (d), (e), (f′) and (g′):

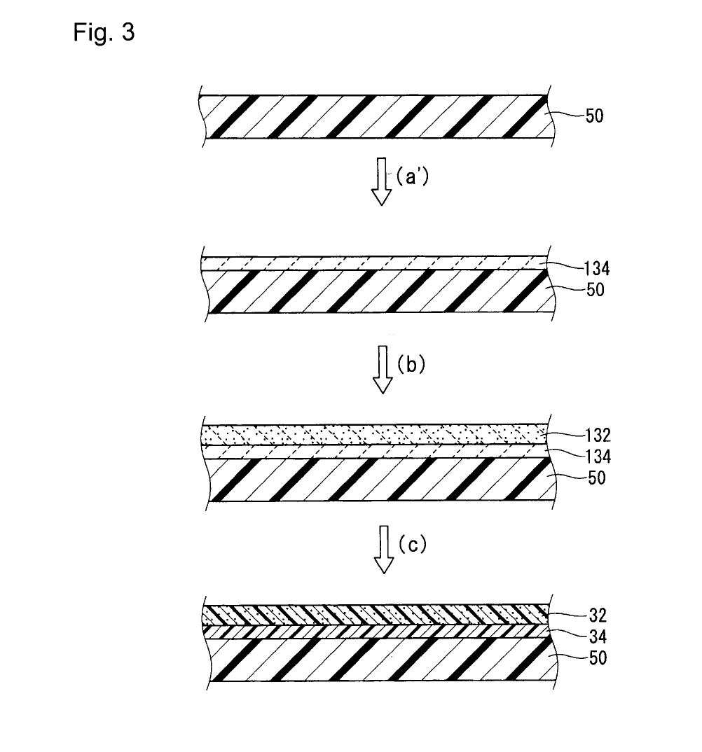

(a′) a step of forming a first wet film 134 by coating the surface of a first carrier film 50 with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis, as shown in FIG. 3,

(b) a step of forming a second wet film 132 by coating the surface of the first wet film 134 with a paste for forming a cathode catalyst layer, subsequent to the step (a′), said paste comprising a catalyst, an ion exchange resin and a liquid medium, as shown in FIG. 3,

(c) a step of forming an interlayer 34 and a catalyst layer 32, by drying the first wet film 134 and the second wet film 132, subsequent to the step (b), as shown in FIG. 3,

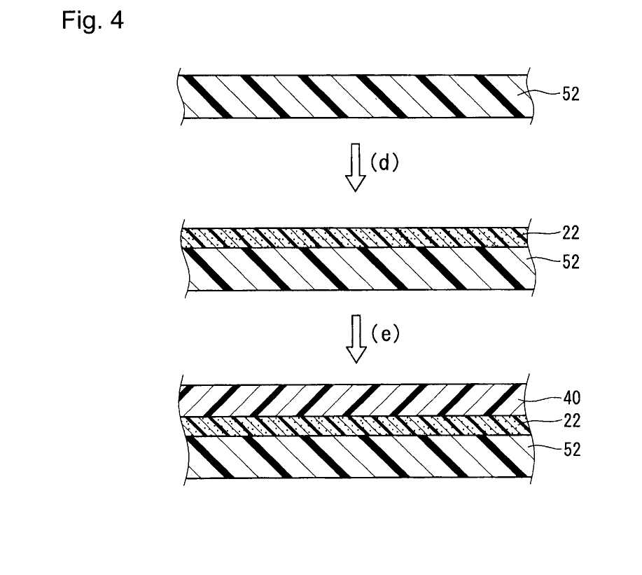

(d) a step of forming a catalyst layer 22 by coating the surface of a second carrier film 52 with a paste for forming an anode catalyst layer, said paste comprising a catalyst, an ion exchange resin and a liquid medium, followed by drying, as shown in FIG. 4,

(e) a step of forming a polymer electrolyte membrane 40 by coating the surface of the catalyst layer 22 with a coating fluid for forming a polymer electrolyte membrane containing an ion exchange resin and a liquid medium, followed by drying, subsequent to the step (d), as shown in FIG. 4,

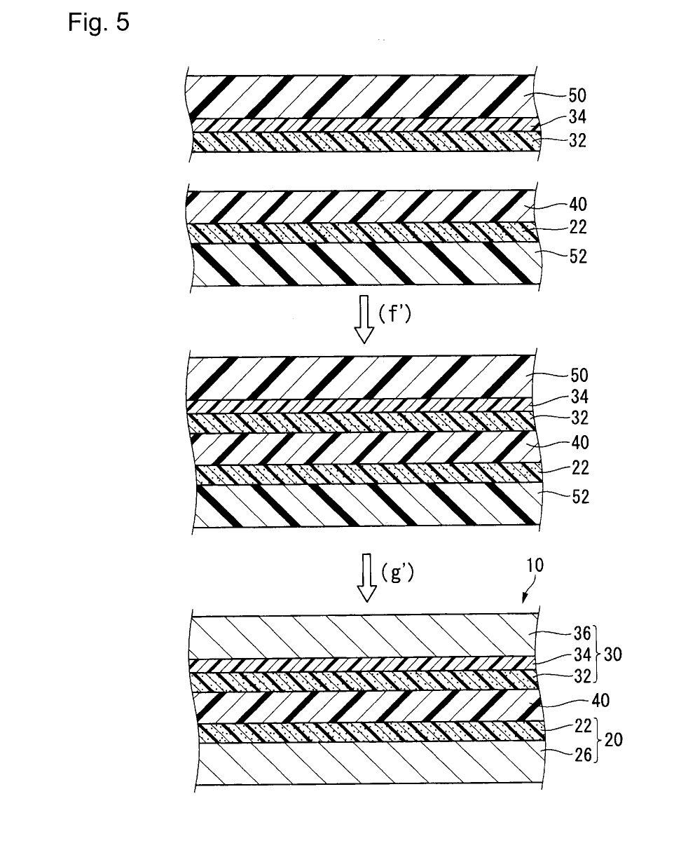

(f′) a step of obtaining an interlayer-provided membrane/catalyst layer assembly by assembling the first carrier film 50 the surface of which is formed with the interlayer 34 and the catalyst layer 32, and the second carrier film 52 formed with the catalyst layer 22 and the polymer electrolyte membrane 40 so that the catalyst layer 32 is in contact with the polymer electrolyte membrane 40, subsequent to the step (c) and the step (e), as shown in FIG. 5, and

(g′) a step of obtaining the membrane/electrode assembly 10, by removing the first carrier film 50 and the second carrier film 52, and assembling a gas diffusing base material to constitute a gas diffusion layer 26, the interlayer-provided membrane/catalyst layer assembly and a gas diffusing base material to constitute a gas diffusion layer 36, so that the catalyst layer 22 is in contact with the gas diffusing base material to constitute the gas diffusion layer 26, and the interlayer 34 is in contact with the gas diffusing base material to constitute the gas diffusion layer 36, subsequent to the step (f′), as shown in FIG. 5.

Step (a′):

The paste for forming an interlayer contains a carbon material, a polymer and a liquid medium.

The liquid medium is preferably one containing an organic solvent and water.

The organic solvent is preferably an alcohol.

The alcohol may, for example, be a non-fluorinated alcohol (such as methanol, ethanol, 1-propanol or 2-propanol), or a fluorinated alcohol (such as 2,2,2-trifluoroethanol, 2,2,3,3,3-pentafluoro-1-propanol, 2,2,3,3-tetrafluoro-1-propanol, 4,4,5,5,5-pentafluoro-1-pentanol, 1,1,1,3,3,3-hexafluoro-2-propanol, 3,3,3-trifluoro-1-propanol, 3,3,4,4,5,5,6,6,6-nonafluoro-1-hexanol or 3,3,4,4,5,5,6,6,7,7,8,8,8-tridecafluoro-1-octanol).

The ratio of the organic solvent to water (organic solvent:water) is preferably from 55:45 to 30:70 (mass ratio), more preferably from 50:50 to 40:60 (mass ratio). When the ratio of the organic solvent is at most the above upper limit value (the ratio of water is at least the above lower limit value), cracking hardly occurs to the catalyst layer 32. When the ratio of the organic solvent is at least the above lower limit value (the ratio of water is at most the above upper limit value), the dispersion stability of the paste for forming an interlayer becomes good, and further cracking hardly occurs to the surface of the first wet film 134 when the surface of the first wet film 134 is coated with the paste for forming a cathode catalyst layer.

The solid content concentration of the paste for forming an interlayer is preferably from 5 to 40 mass %, more preferably from 8 to 30 mass %, particularly preferably from 10 to 25 mass %. When the solid content concentration is at least the above lower limit value, it is possible to form the first wet film 134 by one application. When the solid content concentration is at most the above upper limit value, the dispersed state of the carbon material can be maintained for a long period of time, whereby it is possible to achieve a viscosity suitable for coating by a die coater.

The solid content concentration of the paste for forming an interlayer is represented by the proportion of the sum of the mass of the carbon material and the mass of the polymer in the total mass of the paste.

The mass ratio (polymer/carbon material) of the polymer to the carbon material contained in the paste for forming an interlayer is preferably from 0.5 to 1.5, more preferably from 0.5 to 1.2. When the mass ratio of “polymer/carbon material” is at least the above lower limit value, the moisture retention of the interlayer 34 increases, whereby it is possible to suppress drying of the polymer electrolyte membrane 40. When the mass ratio of “polymer/carbon material” is at most the above upper limit value, it is possible to prevent deterioration of the gas permeability of the interlayer 34.

The viscosity of the paste for forming an interlayer at a shear rate of 200 (1/s) as measured at 25° C. by using an RE550 viscometer (manufactured by TOKI SANGYO CO., LTD.) for flow analysis is from 250 to 450 mPa·s, preferably from 300 to 40 mPa·s. When the viscosity of the paste for forming an interlayer is at least the above lower limit value, the first wet film 134 becomes less likely to spread in the plane direction along the surface of the carrier film, whereby the second wet film 132 is less likely to be stretched in the plane direction at the time of drying the first wet film 134 and the second wet film 132, and as a result, cracking is less likely to occur to the catalyst layer 32. When the viscosity of the paste for forming an interlayer is at most the above upper limit, stripe-like uneven coating is less likely to occur to the first wet film 134, and as a result, stripe-like uneven coating is less likely to occur to the catalyst layer 32.

The paste for forming an interlayer may, for example, be prepared as follows.

A polymer is dispersed in a part of the liquid medium to prepare a polymer dispersion.

A carbon material, the rest of the liquid medium and the polymer dispersion are mixed and dispersed to obtain a paste for forming an interlayer. At the time of mixing and dispersing them, it is preferred to use a ultrasonic disperser. For example, by selecting a suitable stirrer and dispersing device or controlling a stirring time, the viscosity of the paste for forming an interlayer can be adjusted to be within the above range. Incidentally, in the case of a coating fluid for forming an interlayer described in Examples of Patent Document 1, a homogenizer is used at the time of preparation, and the viscosity at a shear rate of 200 (1/s) as measured at 25° C. by using an RE550 viscometer (manufactured by TOKI SANGYO CO., LTD.) for flow analysis, is about 150 mPa·s.

The first carrier film 50 may, for example, be an ethylene/tetrafluoroethylene copolymer (hereinafter referred to as ETFE) film or an olefin resin film.

As a method of coating the paste for forming an interlayer, a known method such as a die coating method may be employed.

### Step (b):

The paste for forming a cathode catalyst layer contains a catalyst, an ion exchange resin and a liquid medium.

The liquid medium is preferably one containing an organic solvent and water.

The organic solvent is preferably an alcohol.

The alcohol may be the same as the alcohol exemplified as the liquid medium for the paste for forming an interlayer.

The ratio (organic solvent/water) of the organic solvent to the water is preferably from 70:30 to 45:55 (mass ratio), more preferably from 60:40 to 50:50 (mass ratio). When the ratio of the organic solvent is at most the above upper limit value (the ratio of water is at least the above lower limit value), the surface tension of the paste will not be too low, whereby the paste will easily be applied.

When the ratio of the organic solvent is at least the above lower limit value (the ratio of water is at most the above upper limit value), cracking is less likely to occur to the catalyst layer 32.

The solid content concentration of the paste for forming a cathode catalyst layer is preferably from 3 to 18 mass %, more preferably from 5 to 14 mass %, particularly preferably from 6 to 10 mass %. When the solid content concentration is at least the above lower limit value, it becomes possible to form the second wet film 132 by one application. When the solid content concentration is at most the above upper limit value, the dispersion stability of the catalyst becomes good, it is possible to easily form the catalyst layer with a low platinum amount, and the state can be maintained for a long period of time.

The solid content concentration of the paste for forming a cathode catalyst layer is represented by the proportion of the sum of the mass of the catalyst and the ion exchange resin in the total mass of the paste.

The mass ratio (ion exchange resin/carbon) of the ion exchange resin to carbon in the catalyst, in the paste for forming a cathode catalyst layer, is preferably from 0.4 to 1.6, particularly preferably from 0.6 to 1.2, from the viewpoint of power generation performance of a polymer electrolyte fuel cell.

The paste for forming a cathode catalyst layer may, for example, be prepared as follows.

An ion exchange resin is dispersed in a part of the liquid medium to prepare an ion exchange resin dispersion.

A catalyst, the rest of the liquid medium and the ion exchange resin dispersion are mixed and stirred to obtain a paste for forming a cathode catalyst layer.

As a method of applying the paste for forming a cathode catalyst layer at room temperature, a known method such as a die coating method may be employed.

The time from the completion of the step (a) to the start of the step (b) is preferably within 3 minutes, more preferably within 1 minute. When the time from the completion of the step (a) to the start of the step (b) is within 1 minute, air drying of the first wet film 134 can be suppressed, whereby the adhesion at the interface between the interlayer 34 and the catalyst layer 32 formed after drying the first wet film 134 and the second wet film 132 becomes sufficiently high.

The step (b) is carried out while the remaining ratio of the liquid medium in the first wet film 134 formed is preferably at least 40%, more preferably at least 60%, whereby the adhesion at the interface between the interlayer 34 and the catalyst layer 32 formed after drying the first wet film 134 and the second wet film 132 becomes sufficiently high.

### Step (c):

A temperature for drying is preferably from 40 to 130° C., more preferably from 45 to 80° C.

As a method for drying, a known method may be employed.

### Step (d):

The paste for forming an anode catalyst layer contains a catalyst, an ion exchange resin and a liquid medium.

The component, composition, etc. of the paste for forming an anode catalyst layer may be the same or different from those of the paste for forming a cathode catalyst layer.

The liquid medium may be the same as one exemplified as the liquid medium in the paste for forming a cathode catalyst layer.

A preferred embodiment of the paste for forming an anode catalyst layer is the same as the preferred embodiment of the paste for forming a cathode catalyst layer.

The paste for forming an anode catalyst layer is prepared in the same manner as in the paste for forming a cathode catalyst layer.

The second carrier film 52 may, for example, be an ETFE film, or an olefin resin film.

As a method of applying the paste for forming an anode catalyst layer, a known method such as a die coating method may be employed.

A temperature for drying is preferably from 40 to 130° C., more preferably from 45 to 80° C.

As a method for drying, a known method may be employed.

### Step (e):

The coating fluid for forming a polymer electrolyte membrane contains an ion exchange resin and a liquid medium.

The liquid medium is preferably one containing an organic solvent and water.

The organic solvent is preferably an alcohol.

The alcohol may be the same as the alcohol exemplified as the liquid medium in the paste for forming an interlayer.

The solid content concentration of the coating fluid for forming a polymer electrolyte membrane is preferably from 10 to 40 mass %, more preferably from 15 to 35 mass %, particularly preferably from 25 to 30 mass %. When the solid content concentration is at least the above lower limit value, it becomes possible to form the polymer electrolyte membrane 40 by one or two applications. When the solid content concentration is at most the above upper limit value, the viscosity of the coating fluid is suitable for application by a die coater.

The solid content concentration of the coating fluid for forming a polymer electrolyte membrane is represented by the proportion of the mass of the ion exchange resin in the total mass of the coating fluid.

The coating fluid for forming a polymer electrolyte membrane may, for example, be prepared as follows.

An ion exchange resin is dispersed in the liquid medium to prepare an ion exchange resin dispersion, and this dispersion is regarded as a coating fluid for forming a polymer electrolyte membrane.

As a method of applying the coating fluid for forming a polymer electrolyte membrane, a known method such as a die coating method may be employed.

A temperature for drying is preferably from 40 to 130° C., more preferably from 70 to 120° C.

As a method for drying, a known method may be employed.

Step (f′) and Step (g′):

The bonding method may, for example, be a hot press method, a hot roll press method or an ultrasonic fusion method, and from the viewpoint of the in-plane uniformity, a hot press method is preferred.

The temperature of the pressing plate in the press machine is preferably from 100 to 150° C.

The pressing pressure is preferably from 0.5 to 4.0 MPa.

### (Process (β))

In a case where the membrane/electrode assembly 10 as shown in FIG. 1 is produced, the process (β) has e.g. the following steps (a″), (b), (c), (d), (e), (f″) and (g″).

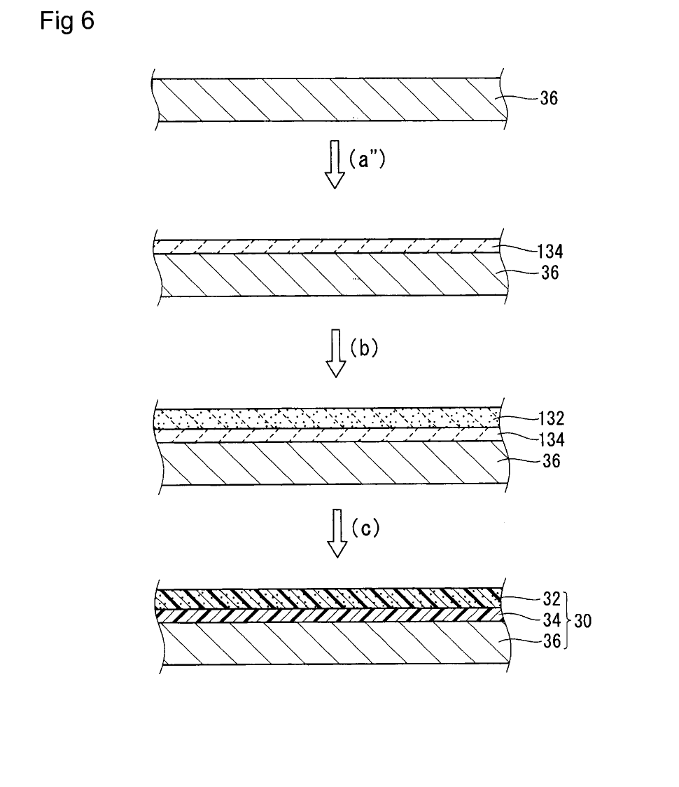

(a″) A step of forming a first wet film 134 by coating the surface of a gas diffusing base material to constitute a gas diffusion layer 36, with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis, as shown in FIG. 6.

(b) A step of forming a second wet film 132 by coating the surface of the first wet film 134 with a paste for forming a cathode catalyst layer, subsequent to the step (a″), said paste comprising a catalyst, an ion exchange resin and a liquid medium, as shown in FIG. 6.

(c) A step of forming an interlayer 34 and a catalyst layer 32, by drying the first wet film 134 and the second wet film 132, subsequent to the step (b), to obtain a cathode 30, as shown in FIG. 6.

(d) A step of coating the surface of a second carrier film 52 with a paste for forming an anode catalyst layer comprising a catalyst, an ion exchange resin and a liquid medium, followed by drying to form a catalyst layer 22, as shown in FIG. 4.

(e) A step of coating the surface of the catalyst layer 22 with a coating fluid for forming a polymer electrolyte membrane containing an ion exchange resin and a liquid medium, followed by drying to form a polymer electrolyte membrane 40, subsequent to the step (d), as shown in FIG. 4.

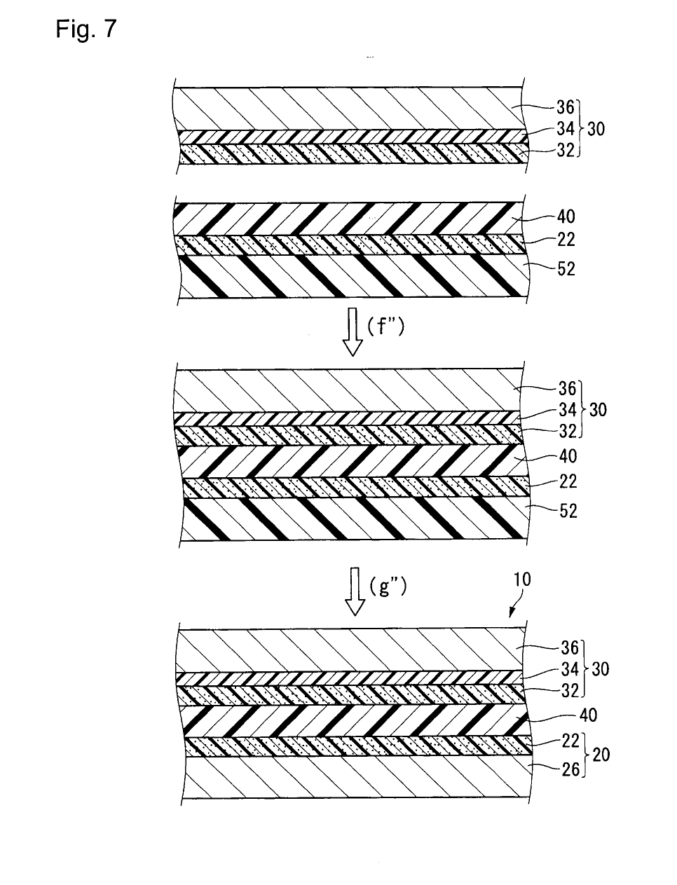

(f″) A step of assembling the cathode 30 and the second carrier film 52 formed with the catalyst layer 22 and the polymer electrolyte membrane 40 so that the catalyst layer 32 is in contact with the polymer electrolyte membrane 40, to obtain a precursor for a membrane/electrode assembly, subsequent to the steps (c) and (e), as shown in FIG. 7.

(g″) A step of removing the second carrier film 52, and assembling a gas diffusing base material to constitute a gas diffusion layer 26 and the precursor for a membrane/electrode assembly so that the catalyst layer 22 is in contact with a gas diffusing base material to constitute a gas diffusion layer 26, to obtain a membrane/electrode assembly 10, subsequent to the step (f″), as shown in FIG. 7.

Step (a″):

The step (a″) in the process (β) may be carried out in the same manner as the step (a′) in the process (α) except that the gas diffusing base material is used instead of the first carrier film 50.

The paste for forming an interlayer has a viscosity of from 250 to 450 mPa·s, preferably from 300 to 400 mPa·s at a shear rate of 200 (1/s) as measured at 25° C. by using an RE550 viscometer (manufactured by TOKI SANGYO CO., LTD.) for flow analysis. When the viscosity of the paste for forming an interlayer is at least the above lower limit value, the first wet film 134 is less likely to permeate into the gas diffusing base material, whereby spot-like uneven coating is less likely to occur to the first wet film 134, and as a result, spot-like uneven coating is less likely to occur to the catalyst layer 32. When the viscosity of the paste for forming an interlayer is at most the above upper limit value, stripe-like uneven coating is less likely to occur to the first wet film 134, and as a result, stripe-like unevenness is less likely to occur to the catalyst layer 32.

### Steps (b), (c), (d) and (e):

The steps (b), (c), (d) and (e) in the process (β) may be carried out in the same manner as the steps (b), (c), (d) and (e) in the process (α), respectively.

Step (f′):

The step (f′) in the process (β) may be carried out in the same manner as the step (f′) in the process (α).

Step (g″):

The step (g″) in the process (β) may be carried out in the same manner as the step (g′) in the process (α) except that the gas diffusion layer 36 is already present instead of the first carrier film 50, only the second carrier film 52 is removed, and the gas diffusing base material is bonded thereto.

### (Mechanism of Action)

In the case of the process for producing a membrane/electrode assembly of the present invention as described above, the surface of a base material is coated with the paste for forming an interlayer to form the first wet film, and then the surface of the first wet film is coated with the paste for forming a catalyst layer to form the second wet film, without positively drying the first wet film by heating, whereby the pastes constituting the first wet film and the second wet film are partly mixed with each other at the interface between the respective wet films. Thereafter, the first wet film and the second wet film are dried to form an interlayer and a catalyst layer, and therefore materials constituting the interlayer and the catalyst layer are partly mixed with each other at the interface between the respective layers. Accordingly, the adhesion at the interface between the interlayer and the catalyst layer increases. As a result, the effect of improving power generation performance of a membrane/electrode assembly by providing the interlayer between the catalyst layer and the gas diffusion layer is sufficiently exhibited.

Further, in the process for producing a membrane/electrode assembly of the present invention as described above, as the paste for forming an interlayer, one having a viscosity of from 250 to 450 mPa·s at a shear rate of 200 (1/s) as measured at 25° C. by using an RE550 viscometer (manufactured by TOKI SANGYO CO., LTD.) for flow analysis, is used, and therefore cracking or stripe-like unevenness is less likely to occur to the catalyst layer adjacent to the interlayer. As a result, the power generation performance of the membrane/electrode assembly can sufficiently be exhibited.

### Other Embodiments

The process for producing a membrane/electrode assembly of the present invention is not limited to the production process shown in Figures, so long as it is a process having at least the above-mentioned steps (a), (b) and (c).

For example, the production process may be a process for producing a membrane/electrode assembly in which the anode 20 has the interlayer 24 between the catalyst layer 22 and the gas diffusion layer 26, as shown in FIG. 2.

Further, it may be a process for producing a membrane/electrode assembly in which the cathode 30 has at least two interlayers, or a process for producing a membrane/electrode assembly in which the anode 20 has at least two interlayers. In a case where one electrode has at least two interlayers, the interlayer adjacent to the catalyst layer is a layer formed by drying the first wet film.

### <Polymer Electrolyte Fuel Cell>

The membrane/electrode assembly of the present invention is used for a polymer electrolyte fuel cell. A polymer electrolyte fuel cell is produced, for example, by sandwiching a membrane/electrode assembly between two separators to form a cell, and stacking a plurality of such cells.

As a separator, an electrically conductive carbon plate having grooves formed to constitute flow paths for a fuel gas or an oxidant gas containing oxygen (such as air or oxygen) may, for example, be mentioned.

As a type of the polymer electrolyte fuel cell, a hydrogen/oxygen type fuel cell or a direct methanol type fuel cell (DMFC) may, for example, be mentioned. Methanol or a methanol aqueous solution to be used as a fuel for DMFC may be a liquid feed or a gas feed.

### EXAMPLES

Now, the present invention will be described in detail with reference to Examples. However, it should be understood that the present invention is by no means restricted to such specific Examples.

Ex. 12 to 14, 17 to 19 and 21 to 24 are Examples of the present invention, and Ex. 1 to 11, 15, 16 and 20 are Comparative Examples.

### (Viscosity of Paste for Forming Interlayer)

The viscosity of a paste for forming an interlayer was measured at a shear rate of 200 (1/s) at 25° C. by using a viscometer for flow analysis (manufactured by TOKI SANGYO CO., LTD., RE550).

### (Surface Condition of Cathode Catalyst Layer)

The surface of a cathode catalyst layer was visually observed to confirm the presence or absence of cracking and the presence or absence of unevenness.

### (Cell Voltage)

Under atmospheric pressure, hydrogen (utilization ratio: 70%)/oxygen (utilization ratio: 50%) was supplied to a cell for power generation, whereby at a cell temperature of 80° C., the cell voltage at the initial stage of the operation was measured at a current density of 1.0 A/cm². Here, on the anode side, hydrogen with a dew point of 53° C. was supplied, and on the cathode side, air with a dew point of 53° C. was supplied, respectively to the cell (relative humidity in the cell: 30% RH).

### (Polymer (H1) Dispersion (A))

Polymer (H1) (ion exchange capacity: 1.1 meq/g dry resin) comprising units based on TFE and units (U1-11), was dispersed in ethanol/water=6/4 (mass ratio) to prepare a polymer (H1) dispersion (A) having a solid content of 20 mass %.

(Polymer (H1) Dispersion (B)) Polymer (H1) (ion exchange capacity: 1.1 meq/g dry resin) comprising units based on TFE and units (U1-11), was dispersed in ethanol/water=6/4 (mass ratio) to prepare a polymer (H1) dispersion (B) having a solid content of 15 mass %.

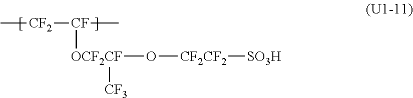

### (Paste (1) for Forming Interlayer)

To 50 g of vapor phase-grown carbon fibers (tradename: VGCF-H manufactured by Showa Denko K.K., average fiber diameter: about 150 nm, fiber length: 10 to 20 μm), 90 g of ethanol and 110 g of water were added, followed by thorough stirring. Added thereto was 125.0 g of the polymer (H1) dispersion (A), followed by thorough stirring. Further, dispersing and mixing were carried out by means of an ultrasonic disperser to obtain a paste (1) for forming an interlayer having a solid content concentration of 20 mass %. The viscosity at a shear rate of 200 (1/s) as measured at 25° C. by using an RE550 viscometer (manufactured by TOKI SANGYO CO., LTD.) for flow analysis, was 120 mPa·s.

### (Paste (2) for Forming Interlayer)

A paste (2) for forming an interlayer was obtained in the same manner as the paste (1) for forming an interlayer, except that a dispersion treatment time employing the ultrasonic disperser was changed. The viscosity at a shear rate of 200 (1/s) as measured at 25° C. by using an RE550 viscometer (manufactured by TOKI SANGYO CO., LTD.) for flow analysis was 250 mPa·s.

### (Paste (3) for Forming Interlayer)

A paste (3) for forming an interlayer was obtained in the same manner as the paste (1) for forming an interlayer, except that a dispersion treatment time employing the ultrasonic disperser was changed. The viscosity at a shear rate of 200 (1/s) as measured at 25° C. by using an RE550 viscometer (manufactured by TOKI SANGYO CO., LTD.) for flow analysis was 350 mPa·s.

### (Paste (4) for Forming Interlayer)

A paste (4) for forming an interlayer was obtained in the same manner as the paste (1) for forming an interlayer, except that a dispersion treatment time employing the ultrasonic disperser was changed. The viscosity at a shear rate of 200 (1/s) as measured at 25° C. by using an RE550 viscometer (manufactured by TOKI SANGYO CO., LTD.) for flow analysis was 450 mPa·s.

### (Paste (5) for Forming Interlayer)

A paste (5) for forming an interlayer was obtained in the same manner as the paste (1) for forming an interlayer, except that a dispersion treatment time employing the ultrasonic disperser was changed. The viscosity at a shear rate of 200 (1/s) as measured at 25° C. by using an RE550 viscometer (manufactured by TOKI SANGYO CO., LTD.) for flow analysis was 550 mPa·s.

### (Paste (6) for Forming Interlayer)

To 50 g of vapor phase-grown carbon fibers (tradename: VGCF-H manufactured by Showa Denko K.K., average fiber diameter: about 150 nm, fiber length: 10 to 20 μm), 120 g of ethanol and 80 g of water were added, followed by thorough stirring. Added thereto was 125.0 g of the polymer (H1) dispersion (A), followed by thorough stirring. Further, dispersing and mixing were carried out by means of an ultrasonic disperser to obtain a paste (6) for forming an interlayer having a solid content concentration of 20 mass %. The viscosity at a shear rate of 200 (1/s) as measured at 25° C. by using an RE550 viscometer (manufactured by TOKI SANGYO CO., LTD.) for flow analysis, was 250 mPa·s.

### (Paste (7) for Forming Interlayer)

To 50 g of vapor phase-grown carbon fibers (tradename: VGCF-H manufactured by Showa Denko K.K., average fiber diameter: about 150 nm, fiber length: 10 to 20 μm), 60 g of ethanol and 140 g of water were added, followed by thorough stirring. Added thereto was 125.0 g of the polymer (H1) dispersion (A), followed by thorough stirring. Further, dispersing and mixing were carried out by means of an ultrasonic disperser to obtain a paste (7) for forming an interlayer having a solid content concentration of 20 mass %. The viscosity at a shear rate of 200 (1/s) as measured at 25° C. by using an RE550 viscometer (manufactured by TOKI SANGYO CO., LTD.) for flow analysis, was 250 mPa·s.

(Paste (a1) for Forming Cathode Catalyst Layer)

10.0 g of a catalyst (manufactured by Tanaka Kikinzoku Kogyo, TEC36F62) having a platinum/cobalt alloy (platinum:cobalt=57:6 in a mass ratio) in a proportion of 63% based on the total mass of the catalyst, supported on a carbon carrier, was added to 53.6 g of distilled water, followed by thorough stirring. Further, 51.2 g of ethanol was added, followed by thorough stirring. 14.8 g of the polymer (H1) dispersion was added thereto, and mixed and pulverized by means of a planetary ball mill to obtain a paste (a1) for forming a cathode catalyst layer having a solid content concentration of 10 mass %.

(Paste (a2) for Forming Cathode Catalyst Layer)

10.0 g of a catalyst (manufactured by Tanaka Kikinzoku Kogyo, TEC36F62) having a platinum/cobalt alloy (platinum:cobalt=57:6 in a mass ratio) in a proportion of 63% based on the total mass of the catalyst, supported on a carbon carrier, was added to 41.9 g of distilled water, followed by thorough stirring. Further, 62.9 g of ethanol was added, followed by thorough stirring. 14.8 g of the polymer (H1) dispersion was added thereto, and mixed and pulverized by means of a planetary ball mill to obtain a paste (a2) for forming a cathode catalyst layer having a solid content concentration of 10 mass %.

(Paste (a3) for Forming Cathode Catalyst Layer)

10.0 g of a catalyst (manufactured by Tanaka Kikinzoku Kogyo, TEC36F62) having a platinum/cobalt alloy (platinum:cobalt=57:6 in a mass ratio) in a proportion of 63% based on the total mass of the catalyst, supported on a carbon carrier, was added to 65.3 g of distilled water, followed by thorough stirring. Further, 39.6 g of ethanol was added, followed by thorough stirring. 14.8 g of the polymer (H1) dispersion was added thereto, and mixed and pulverized by means of a planetary ball mill to obtain a paste (a3) for forming a cathode catalyst layer having a solid content concentration of 10 mass %.

### (Paste for Forming Anode Catalyst Layer)

To 10 g of a catalyst (manufactured by Tanaka Kikinzoku Kogyo, TEC10EA20E) having a platinum in a proportion of 20% based on the total mass of the catalyst, supported on a carbon carrier, 84.1 g of distilled water, 78.9 g of ethanol and 32.0 g of polymer (H1) dispersion were added in a nitrogen atmosphere, followed by thorough stirring, and mixed and pulverized by means of a planetary ball mill to obtain a paste for forming an anode catalyst layer having a solid content concentration of 8 mass %.

### Ex. 1

### Step (a′)+Drying

While an ETFE film was conveyed at a rate of 2 m/min, the surface of the ETFE film was coated with the paste (1) for forming an interlayer by a die coater so that the solid content would be 3 mg/cm², followed by drying at 120° C. to form an interlayer.

### Step (b)+Drying

While the interlayer-provided ETFE film was conveyed at a rate of 2 m/min, the surface of the interlayer was coated with the paste (a1) for forming a cathode catalyst layer by a die coater so that the amount of platinum would be 0.35 mg/cm², followed by drying at 120° C. to form a cathode catalyst layer.

### Step (d)

While an ETFE film was conveyed at a rate of 2 m/min, the surface of the ETFE film was coated with a paste for forming an anode catalyst layer by a die coater so that the amount of platinum would be 0.05 mg/cm², followed by drying to form an anode catalyst layer.

### Step (e)

While the anode catalyst layer-provided ETFE film was conveyed at a rate of 2 m/min, the surface of the anode catalyst layer was coated with the polymer (H1) dispersion (B) twice by a die coater so that the total film thickness after drying would be 17 μm, followed by drying to form a polymer electrolyte membrane.

### Step (f′)

The ETFE film the surface of which was formed with the interlayer and the cathode catalyst layer, and the ETFE film formed with the anode catalyst layer and the polymer electrolyte membrane, were bonded by a hot press method so that the cathode catalyst layer would be in contact with the polymer electrolyte membrane to obtain an interlayer-provided membrane/catalyst layer assembly.

### Step (g′)

After the ETFE films were removed from both surfaces of the interlayer-provided membrane/catalyst layer assembly, a gas diffusing base material (X0086 T10X13, manufactured by NOK Corporation) was disposed on the outside of the interlayer, and a gas diffusing base material (GDL X0086 IX51 CX173, manufactured by NOK corporation) was disposed on the outside of the anode catalyst layer to obtain a membrane/electrode assembly (electrode area: 25 cm²). Further, on the outside of both the gas diffusion layers, carbon separators were disposed to assemble a cell for power generation.

Evaluation results of the surface conditions of the cathode catalyst layer and measurement results of the cell voltage are shown in Table 1.

### Ex. 2

A membrane/electrode assembly (electrode area: 25 cm²) was obtained in the same manner as in Example 1 except that the paste (2) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and measurement results of the cell voltage are shown in Table 1.

### Ex. 3

A membrane/electrode assembly (electrode area: 25 cm²) was obtained in the same manner as in Example 1 except that the paste (3) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and measurement results of the cell voltage are shown in Table 1.

### Ex. 4

A membrane/electrode assembly (electrode area: 25 cm²) was obtained in the same manner as in Example 1 except that the paste (4) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and measurement results of the cell voltage are shown in Table 1.

### Ex. 5

A membrane/electrode assembly (electrode area: 25 cm²) was obtained in the same manner as in Example 1 except that the paste (5) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and measurement results of the cell voltage are shown in Table 1.

### Ex. 6

### Step (a″)+Drying

While a gas diffusing base material (X0086 T10X13, manufactured by NOK Corporation) was conveyed at a rate of 2 m/min, the surface of the gas diffusing base material was coated with the paste (1) for forming an interlayer by a die coater so that the solid content would be 3 mg/cm², followed by drying at 120° C. to form an interlayer.

### Step (b)+Drying

While the interlayer-provided gas diffusing base material was conveyed at a rate of 2 m/min, the surface of the interlayer was coated with the paste (a1) for forming a cathode catalyst layer by a die coater so that the amount of platinum would be 0.35 mg/cm², followed by drying at 120° C. to form a cathode catalyst layer, whereby a cathode was obtained.

### Step (d) and Step (e)

An ETFE film formed with an anode catalyst layer and a polymer electrolyte membrane was obtained in the same manner as in Example 1.

### Step (f′)

The cathode and the ETFE film formed with the anode catalyst layer and the polymer electrolyte membrane were bonded by a hot press method so that the cathode catalyst layer would be in contact with the polymer electrolyte membrane, whereby a precursor for a membrane/electrode assembly was obtained.

### Step (g″)

After the ETFE film was removed from the precursor for a membrane/electrode assembly, a gas diffusing base material (GDL X0086 IX51 CS173, manufactured by NOK Corporation) was disposed on the outside of the anode catalyst layer to obtain a membrane/electrode assembly (electrode area: 25 cm²). Further, on the outside of both the gas diffusion layers, carbon separators were disposed to assemble a cell for power generation.

Evaluation results of the surface conditions of the cathode catalyst layer and the measurement result of the cell voltage are shown in Table 1.

### Ex. 7

A membrane/electrode assembly (electrode area: 25 cm²) was obtained in the same manner as in Example 6 except that the paste (2) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and the measurement result of the cell voltage are shown in Table 1.

### Ex. 8

A membrane/electrode assembly (electrode area: 25 cm²) was obtained in the same manner as in Example 6 except that the paste (3) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and the measurement result of the cell voltage are shown in Table 1.

### Ex. 9

A membrane/electrode assembly (electrode area: 25 cm²) was obtained in the same manner as in Example 6 except that the paste (4) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and the measurement result of the cell voltage are shown in Table 1.

### Ex. 10

A membrane/electrode assembly (electrode area: 25 cm²) was obtained in the same manner as in Example 6 except that the paste (5) for forming an interlayer was used instead of the paste (1) for forming an interlayer. Further, on the outside of both the gas diffusion layers, carbon separators were disposed to assemble a cell for power generation.

Evaluation results of the surface conditions of the cathode catalyst layer and the measurement result of the cell voltage are shown in Table 1.

### Ex. 11

### Step (a′)

While an ETFE film was conveyed at a rate of 2 m/min, the surface of the ETFE film was coated with the paste (1) for forming an interlayer by a first die of a die coater so that the solid content would be 3 mg/cm² to form a first wet film.

### Step (b)

Then, while the first wet film-provided ETFE film was conveyed at a rate of 2 m/min, the surface of the first wet film was coated with the paste (a1) for forming a cathode catalyst layer by a second die which was 60 cm away from the first die so that the amount of platinum would be 0.35 mg/cm² to form a second wet film. The time from completion of the step (a′) to the start of the step (b) was 18 seconds. The remaining ratio of the liquid medium in the first wet film immediately before starting of the step (b) is 70%, as estimated from a calibration curve preliminarily prepared by studying the relation between the time in which the first wet film was left and the remaining ratio of the liquid medium under the same atmosphere as in the step (a′) and the step (b).

### Step (c)

Immediately after the second wet film was formed, the first wet film and the second wet film were dried at 120° C. to obtain an ETFE film the surface of which was formed with an interlayer and a cathode catalyst layer.

### Step (d) and Step (e)

An ETFE film formed with an anode catalyst layer and a polymer electrolyte membrane was obtained in the same manner as in Example 1.

### Step (f′) and Step (g′)

A membrane/electrode assembly (electrode area: 25 cm²) was obtained in the same manner as in Example 1 except that the ETFE film the surface of which was formed with the interlayer and the cathode catalyst layer, and the ETFE film formed with the anode catalyst layer and the polymer electrolyte membrane were changed. Further, on the outside of both the gas diffusion layers, carbon separators were disposed to assemble a cell for power generation.

Evaluation results of the surface conditions of the cathode catalyst layer and the measurement result of the cell voltage are shown in Table 2.

### Ex. 12

A membrane/electrode assembly (electrode area: 25 cm²) was obtained in the same manner as in Example 11 except that the paste (2) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 13

A membrane/electrode assembly (electrode area: 25 cm²) was obtained in the same manner as in Example 11 except that the paste (3) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 14

A membrane/electrode assembly (electrode area: 25 cm²) was obtained in the same manner as in Example 11 except that the paste (4) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 15

A membrane/electrode assembly (electrode area: 25 cm²) was obtained in the same manner as in Example 11 except that the paste (5) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 16

### Step (a″)

While a gas diffusing base material (X0086 T10X13, manufactured by NOK Corporation) was conveyed at a rate of 2 m/min, the surface of the gas diffusing base material was coated with the paste (1) for forming an interlayer by a first die of a die coater so that the solid content would be 3 mg/cm² to form a first wet film.

### Step (b)

Then, while the first wet film-provided gas diffusing base material was conveyed at a rate of 2 m/min, the surface of the first wet film was coated with the paste (a1) for forming a cathode catalyst layer by a second die which was 60 cm away from the first die so that the amount of platinum would be 0.35 mg/cm², whereby a second wet film was formed. The remaining ratio of the liquid medium in the first wet film immediately before starting of the step (b), estimated from the calibration curve preliminarily prepared, is 70%.

### Step (c)

Immediately after forming the second wet film, the first wet film and the second wet film were dried at 120° C. to form a cathode interlayer and a cathode catalyst layer, whereby a cathode was obtained.

### Step (d) and Step (e)

An ETFE film formed with an anode catalyst layer and a polymer electrolyte membrane was obtained in the same manner as in Example 1.

### Step (f″) and Step (g″)

A membrane/electrode assembly (electrode area: 25 cm²) was obtained in the same manner as in Example 6 except that the cathode and the ETFE film formed with the anode catalyst layer and the polymer electrolyte membrane were changed. Further, carbon separators were disposed on the outside of both the gas diffusing base materials to assemble a cell for power generation.

Evaluation results of the surface conditions of the cathode catalyst layer and the measurement result of the cell voltage are shown in Table 2.

### Ex. 17

A membrane/electrode assembly (electrode area: 25 cm²) was obtained in the same manner as in Example 16 except that the paste (2) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 18

A membrane/electrode assembly (electrode area: 25 cm²) was obtained in the same manner as in Example 16 except that the paste (3) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 19

A membrane/electrode assembly (electrode area: 25 cm²) was obtained in the same manner as in Example 16 except that the paste (4) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 20

A membrane/electrode assembly (electrode area: 25 cm²) was obtained in the same manner as in Example 16 except that the paste (5) for forming an interlayer was used instead of the paste (1) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 21

A membrane/electrode assembly (electrode area: 25 cm²) was obtained in the same manner as in Example 12 except that the paste (6) for forming an interlayer was used instead of the paste (2) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 22

A membrane/electrode assembly (electrode area: 25 cm²) was obtained in the same manner as in Example 12 except that the paste (a3) for forming a cathode catalyst layer 2 was used instead of the paste (a1) for forming a cathode catalyst layer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 23

A membrane/electrode assembly (electrode area: 25 cm²) was obtained in the same manner as in Example 12 except that the paste (7) for forming an interlayer was used instead of the paste (2) for forming an interlayer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

### Ex. 24

A membrane/electrode assembly (electrode area: 25 cm²) was obtained in the same manner as in Example 12 except that the paste (a2) for forming a cathode catalyst layer was used instead of the paste (a1) for forming a cathode catalyst layer. Further, on the outside of both the gas diffusion layers, carbon separators were disposed to assemble a cell for power generation.

The remaining ratio of the liquid medium in the first wet film immediately before starting of the step (b), estimated from the calibration curve preliminarily prepared, is 70%.

Evaluation results of the surface conditions of the cathode catalyst layer and the measurement result of the cell voltage are shown in Table 2.

TABLE 1

| | Step (a) | | | | Step (b) | | Evaluation | | |
|---|---|---|---|---|---|---|---|---|---|
| | Paste for forming interlayer | | | | Paste for forming cathode catalyst layer | | | | Cell |
| | | Viscosity | Organic | | | Organic | Cathode catalyst layer | | voltage |
| Ex. | Type | [mPa · s] | solvent:water | Drying | Type | solvent:water | Cracking | Unevenness | [V] |
| 1 | (1) | 120 | 50:50 | Conducted | (a1) | 50:50 | Nil | Nil | 0.55 |
| 2 | (2) | 250 | 50:50 | Conducted | (a1) | 50:50 | Nil | Nil | 0.57 |
| 3 | (3) | 350 | 50:50 | Conducted | (a1) | 50:50 | Nil | Nil | 0.58 |
| 4 | (4) | 450 | 50:50 | Conducted | (a1) | 50:50 | Nil | Nil | 0.57 |
| 5 | (5) | 550 | 50:50 | Conducted | (a1) | 50:50 | Nil | Stripe-like | 0.57 |
| 6 | (1) | 120 | 50:50 | Conducted | (a1) | 50:50 | Nil | Nil | 0.56 |
| 7 | (2) | 250 | 50:50 | Conducted | (a1) | 50:50 | Nil | Nil | 0.57 |
| 8 | (3) | 350 | 50:50 | Conducted | (a1) | 50:50 | Nil | Nil | 0.58 |
| 9 | (4) | 450 | 50:50 | Conducted | (a1) | 50:50 | Nil | Nil | 0.58 |
| 10 | (5) | 550 | 50:50 | Conducted | (a1) | 50:50 | Nil | Stripe-like | 0.58 |

TABLE 2

| | Step (a) | | | | Step (b) | | Evaluation | | |
|---|---|---|---|---|---|---|---|---|---|
| | Paste for forming interlayer | | | | Paste for forming cathode catalyst layer | | | | Cell |
| | | Viscosity | Organic | | | Organic | Cathode catalyst layer | | voltage |
| Ex. | Type | [mPa · s] | solvent:water | Drying | Type | solvent:water | Cracking | Unevenness | [V] |
| 11 | (1) | 120 | 50:50 | Nil | (a1) | 50:50 | Observed | Nil | Unevaluable |
| 12 | (2) | 250 | 50:50 | Nil | (a1) | 50:50 | Somewhat | Nil | 0.63 |
| | | | | | | | observed | | |
| 13 | (3) | 350 | 50:50 | Nil | (a1) | 50:50 | Nil | Nil | 0.63 |
| 14 | (4) | 450 | 50:50 | Nil | (a1) | 50:50 | Nil | Nil | 0.63 |
| 15 | (5) | 550 | 50:50 | Nil | (a1) | 50:50 | Nil | Stripe-like | 0.59 |
| 16 | (1) | 120 | 50:50 | Nil | (a1) | 50:50 | Nil | Spot-like | 0.58 |
| 17 | (2) | 250 | 50:50 | Nil | (a1) | 50:50 | Nil | Nil | 0.62 |
| 18 | (3) | 350 | 50:50 | Nil | (a1) | 50:50 | Nil | Nil | 0.63 |
| 19 | (4) | 450 | 50:50 | Nil | (a1) | 50:50 | Nil | Nil | 0.63 |
| 20 | (5) | 550 | 50:50 | Nil | (a1) | 50:50 | Nil | Stripe-like | 0.58 |
| 21 | (6) | 250 | 60:40 | Nil | (a1) | 50:50 | Somewhat | Nil | 0.60 |
| | | | | | | | observed | | |
| 22 | (2) | 250 | 50:50 | Nil | (a3) | 40:60 | Somewhat | Nil | 0.60 |
| | | | | | | | observed | | |
| 23 | (7) | 250 | 40:60 | Nil | (a1) | 50:50 | Nil | Nil | 0.63 |
| 24 | (2) | 250 | 50:50 | Nil | (a2) | 60:40 | Nil | Nil | 0.62 |

Ex. 1 to 10 are Examples where an interlayer was formed by drying, and the surface of the interlayer was coated with a paste for forming a cathode catalyst layer.

In each of Ex. 1 to 4 and 6 to 9, the adhesion at the interface between the interlayer and the cathode catalyst layer was insufficient, and the cell voltage was low.

In each of Ex. 5 and 10, the viscosity of the paste for forming an interlayer was too high, whereby stripe-like unevenness occurred to the interlayer, and as a result, the stripe-like unevenness also occurred to the catalyst layer. Further, the cell voltage was low.

Ex. 11 to 20 are Examples where the paste for forming an interlayer was applied to form the first wet film, and the surface of the first wet film was coated with the paste for forming a cathode catalyst layer to form the second wet film, followed by drying the first wet film and the second wet film.

In each of Ex. 12 to 14 and 17 to 19, the adhesion at the interface between the interlayer and the cathode catalyst layer was sufficient, and the cell voltage was high.

In Ex. 11, the viscosity of the paste for forming an interlayer was too low, whereby cracking occurred to the cathode catalyst layer.

In Ex. 16, the viscosity of the paste for forming an interlayer was too low, whereby the first wet film penetrated to the gas diffusing base material, spot-like coating unevenness occurred to the first wet film, and as a result, the spot-like unevenness also occurred to the catalyst layer. Further, the cell voltage was low.

In Ex. 15 and 20, the viscosity of the paste for forming an interlayer was too high, whereby the stripe-like coating unevenness occurred to the first wet film, and as a result, the stripe-like unevenness also occurred to the catalyst layer. Further, the cell voltage was low.

Ex. 21 to 24 are Examples which were carried out in the same manner as in Example 12 except that the composition of the liquid medium of the paste for forming an interlayer or the composition of the liquid medium of the paste for forming a cathode catalyst layer was changed.

In Ex. 21, the composition of the liquid medium of the paste for forming an interlayer deviated from the preferred range, whereby cracking partially occurred to the catalyst layer.

In Ex. 22, the composition of the liquid medium of the paste for forming a cathode catalyst layer deviated from the preferred range, whereby cracking partially occurred to the catalyst layer.

In each of Ex. 23 and 24, the adhesion at the interface between the interlayer and the cathode catalyst layer was sufficient, and the cell voltage was high.

### INDUSTRIAL APPLICABILITY

The membrane/electrode assembly obtained by the production process of the present invention is useful as a membrane/electrode assembly for a polymer electrolyte fuel cell having high power generation performance.

### REFERENCE SYMBOLS

10 membrane/electrode assembly,
20 anode
22 catalyst layer
24 interlayer
26 gas diffusion layer
30 cathode
32 catalyst layer
34 interlayer
36 gas diffusion layer
40 polymer electrolyte membrane
50 first carrier film
52 second carrier film
132 second wet film
134 first wet film

The entire disclosure of Japanese Patent Application No. 2014-059973 filed on Mar. 24, 2014 including specification, claims, drawings and summary is incorporated herein by reference in its entirety.

What is claimed is:

1. A process for producing a membrane/electrode assembly for a polymer electrolyte fuel cell, said membrane/electrode assembly comprising an anode having a catalyst layer and a gas diffusion layer, a cathode having a catalyst layer and a gas diffusion layer, and a polymer electrolyte membrane disposed between the catalyst layer of the anode and the catalyst layer of the cathode, wherein either or both of the anode and the cathode have an interlayer between the catalyst layer and the gas diffusion layer,
which process comprises the following steps (a), (b) and (c):
(a) a step of forming a first wet film by coating the surface of a base material with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,
(b) a step of forming a second wet film by coating the surface of the first wet film with a paste for forming a catalyst layer, subsequent to the step (a), said paste comprising a catalyst, an ion exchange resin and a liquid medium, and
(c) a step of forming an interlayer and a catalyst layer, by drying the first wet film and the second wet film, subsequent to the step (b).

2. The process for producing a membrane/electrode assembly for a polymer electrolyte fuel cell according to claim 1, wherein at least the cathode has the interlayer.

3. The process for producing a membrane/electrode assembly for a polymer electrolyte fuel cell according to claim 1, wherein the step (b) is carried out while the remaining ratio of the liquid medium in the first wet film is at least 40%.

4. The process for producing a membrane/electrode assembly for a polymer electrolyte fuel cell according to claim 1, wherein the step (a) is the following step (a′):
(a′) a step of forming a first wet film by coating the surface of a carrier film with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,
which process further comprises the following steps (f′) and (g′):
(f′) a step of obtaining an interlayer-provided membrane/catalyst layer assembly by assembling the polymer electrolyte membrane and the carrier film the surface of which is formed with the interlayer and the catalyst layer so that the catalyst layer is in contact with the polymer electrolyte membrane, subsequent to the step (c), and
(g′) a step of removing the carrier film, and assembling the interlayer-provided membrane/catalyst layer assembly and a gas diffusing base material to constitute the gas diffusion layer so that the interlayer is in contact with the gas diffusing base material, subsequent to the step (f′).

5. The process for producing a membrane/electrode assembly for a polymer electrolyte fuel cell according to claim 1, wherein the step (a) is the following step (a″):
(a″) a step of forming a first wet film by coating the surface of a gas diffusing base material to constitute the gas diffusion layer, with a paste for forming an interlayer, said paste comprising a carbon material, a polymer and a liquid medium and having a viscosity of from 250 to 450 mPa·s at a shear rate of 200 (1/s) as measured at 25° C. by using an RE550 viscometer (manufactured by TOKI SANGYO CO., LTD.) for flow analysis,
which process further comprises the following step (f″):
(f″) a step of assembling the polymer electrolyte membrane and the gas diffusing base material the surface of which is formed with the interlayer and the catalyst layer so that the catalyst layer is in contact with the polymer electrolyte membrane, subsequent to the step (c).

6. The process for producing a membrane/electrode assembly for a polymer electrolyte fuel cell according to claim 1, wherein the paste for forming an interlayer contains an organic solvent and water as the liquid medium, and the ratio of the organic solvent to the water (organic solvent:water) is from 55:45 to 30:70 (mass ratio).

7. The process for producing a membrane/electrode assembly for a polymer electrolyte fuel cell according to claim 1, wherein the paste for forming a catalyst layer contains an organic solvent and water as the liquid medium, and the ratio of the organic solvent to the water (organic solvent:water) is from 70:30 to 45:55 (mass ratio).

8. A paste for forming an interlayer, which is used for producing a membrane/electrode assembly for a polymer electrolyte fuel cell, said membrane/electrode assembly comprising an anode having a catalyst layer and a gas diffusion layer, a cathode having a catalyst layer and a gas diffusion layer, and a polymer electrolyte membrane disposed between the catalyst layer of the anode and the catalyst layer of the cathode, wherein either or both of the anode and the cathode have an interlayer between the catalyst layer and the gas diffusion layer,
which paste comprises a carbon material, a polymer and a liquid medium, and has a viscosity of from 250 to 450 mPa·s at a shear rate of 200 (1/s) as measured at 25° C. by using an RE550 viscometer (manufactured by TOKI SANGYO CO., LTD.) for flow analysis.
